(19) United States
(12) Patent Application Publication
(10) Pub. No.: US 2014/0295771 A1
(43) Pub. Date: Oct. 2, 2014

(54) OFF-LINE DEVICE TESTING USING VIDEO AND AUDIO CODE CONTROL

(71) Applicant: QUALCOMM INCORPORATED, San Diego, CA (US)

(72) Inventors: Keir Finlow-Bates, Kangasala (FI); Koushik Annapureddy, Tampere (FI); Abdelmonaem Lakhzouri, Tampere (FI)

(73) Assignee: Qualcomm Incorporated, San Diego, CA (US)

(21) Appl. No.: 13/852,743

(22) Filed: Mar. 28, 2013

(51) Int. Cl. H04W 24/06

(52) U.S. Cl. CPC H04W 24/06
USPC 455/67.14

(57) ABSTRACT

An apparatus for testing a device (DUT) includes a peripheral controller configured to communicate with an application embedded in the DUT. The application is configured to run self-diagnostic tests. An audio interface is arranged to transmit audio codes between the apparatus and the DUT on the basis of the tests, wherein the peripheral controller is coupled to the audio interface, being configured to encode and decode the audio codes. A method of testing a DUT includes running a DUT embedded application configured to run self-diagnostic tests. Running the application comprises transmitting encoded audio command signals via an audio interface from a testing apparatus to a microphone configured with the DUT to initiate self diagnostic tests, receiving audio response signals from the DUT generated on the basis of the tests via an audio interface configured with the testing apparatus, and decoding the received audio response signals by a peripheral controller.

### BACKGROUND

1. Field

The present disclosure relates generally to wireless communication systems. More specifically the present disclosure related to methods and apparatus for off-line testing of wireless devices using video and/or audio code communication between the wireless device and peripheral test equipment.

2. Background

Wireless communication devices have become smaller and more powerful as well as more capable. Increasingly, users rely on wireless communication devices for mobile phone use as well as email and Internet access. At the same time, devices have become smaller in size. Devices such as cellular telephones, personal digital assistants (PDAs), laptop computers, and other similar devices provide reliable service with expanded coverage areas. Such devices may be referred to as mobile stations, stations, access terminals, user terminals, subscriber units, user equipments, and similar terms.

A wireless communication system may support communication for multiple wireless communication devices at the same time. In use, a wireless communication device may communicate with one or more base stations by transmissions on the uplink and downlink. Base stations may be referred to as access points, Node Bs, or other similar terms. The uplink or reverse link refers to the communication link from the wireless communication device to the base station, while the downlink or forward link refers to the communication from the base station to the wireless communication devices.

Wireless communication systems may be multiple access systems capable of supporting communication with multiple users by sharing the available system resources, such as bandwidth and transmit power. Examples of such multiple access systems include code division multiple access (CDMA) systems, time division multiple access (TDMA) systems, frequency division multiple access (FDMA) systems, wideband code division multiple access (WCDMA) systems, global system for mobile (GSM) communication systems, enhanced data rates for GSM evolution (EDGE) systems, and orthogonal frequency division multiple access (OFDMA) systems.

When testing mobile devices, it is often necessary to verify functionality in “offline”, “airplane” or “mission” mode—that is with no LAN, WWAN, or WAN connectivity available. Although this kind of testing can be conducted with an On-Device test harness, there are problems if the test case requires peripheral test equipment to be controlled, for example a Global Navigation Satellite System (GNSS) simulator, RF switch, relay, temperature chamber or other test equipment. Furthermore, all logging must be on-device, which means that results can only be analyzed and debugged after the test has been run, possibly for a long time. Hence there is no way to detect that a test crash has occurred, issue an alert message, and that the test should be restarted, or to raise other alert issues.

There is a need, therefore, for a simplified test harness interface with the mobile device that enables off-line testing.

### SUMMARY

In an aspect of the disclosure, an apparatus for testing a device under test (DUT) includes a peripheral controller configured to communicate with an application embedded in the DUT, wherein the application is configured to run self diagnostic tests, and an audio interface arranged to transmit to and receive audio codes between the apparatus and the DUT on the basis of the tests, wherein the peripheral controller is coupled to the audio interface, and configured to encode and decode the audio codes.

In an aspect of the disclosure, a method of testing a device under test (DUT) is provided. The method involves using a testing apparatus, and running an application embedded in the DUT that is configured to run self-diagnostic tests, wherein running the application includes transmitting encoded audio command signals via an audio interface from the testing apparatus to a microphone configured with the DUT to initiate the self diagnostic tests, receiving audio response signals from the DUT generated on the basis of the tests via an audio interface configured with the testing apparatus, and decoding the received audio response signals by a peripheral controller.

In an aspect of the disclosure, an apparatus for testing a mobile device under test (DUT) includes an application embedded in the DUT configured to run self-diagnostic tests, an audio interface arranged to transmit and detect audio codes between the apparatus and the DUT on the basis of the tests, and a peripheral controller, coupled to the audio input interface, configured to decode and encode the audio codes.

In an aspect of the disclosure, a method of testing a mobile device under test (DUT) includes running an application configured to run self-diagnostic tests embedded in the DUT, transmitting an audio code from the DUT on the basis of the self diagnostic test to a peripheral controller, decoding the audio code by the peripheral controller; and receiving by the DUT an audio from the peripheral controller on the basis of the decoded audio code emitted by the DUT.

In an aspect of the disclosure, an apparatus for testing a device under test (DUT) includes means for communicating with an application embedded in the DUT, wherein the application is configured to run self diagnostic tests, and means for transmitting and receiving audio codes between the apparatus and the DUT on the basis of the tests, wherein the means for communicating is coupled to the means for transmitting and receiving audio codes, being configured to encode and decode the audio codes.

In an aspect of the disclosure, a non-transitory computer readable media is provided that includes program instructions which when executed by a processor cause the processor to perform the method of off-line testing of a device under test (DUT), the instructions include code for running an application embedded in the DUT configured to run self-diagnostic tests, wherein the application comprises code for transmitting encoded audio command signals via an audio interface from the testing apparatus to a microphone configured with the DUT to initiate the self diagnostic tests, code for receiving audio response signals from the DUT generated on the basis of the tests via an audio interface configured with the testing apparatus, and code for decoding the received audio response signals by a peripheral controller.

### BRIEF DESCRIPTION OF THE DRAWINGS

FIG. 1 is a diagram illustrating an example of a network architecture according to an embodiment.

FIG. 2 is a diagram illustrating an example of an access network according to an embodiment.

FIG. 3 illustrates a first configuration of an off-line mobile device test system using an optical display interface in accordance with certain embodiments of the disclosure.

FIG. 4 illustrates a second configuration of an off-line mobile device test system using an audio interface in accordance with certain embodiments of the disclosure.

FIG. 5 is a block diagram illustrating a method of testing a DUT in accordance with certain embodiments of the disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, the term “determining” encompasses a wide variety of actions and therefore, “determining” can include calculating, computing, processing, deriving, investigating, looking up (e.g., looking up in a table, a database or another data structure), ascertaining and the like. Also, “determining” can include resolving, selecting choosing, establishing, and the like.

The phrase “based on” does not mean “based only on,” unless expressly specified otherwise. In other words, the phrase “based on” describes both “based only on” and “based at least on.”

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM, and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Disk and disc, as used herein, includes compact disk (CD), laser disk, optical disc, digital versatile disk (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

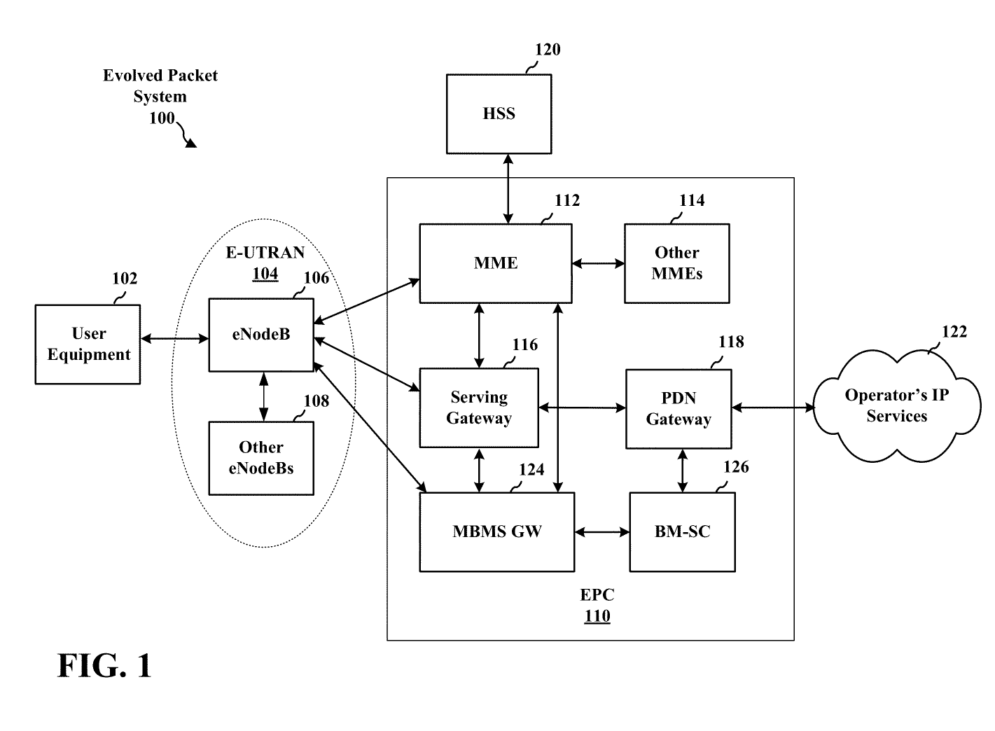

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 includes a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 is the source of MBMS traffic. The MBMS Gateway 124 distributes the MBMS traffic to the eNBs 106, 108.

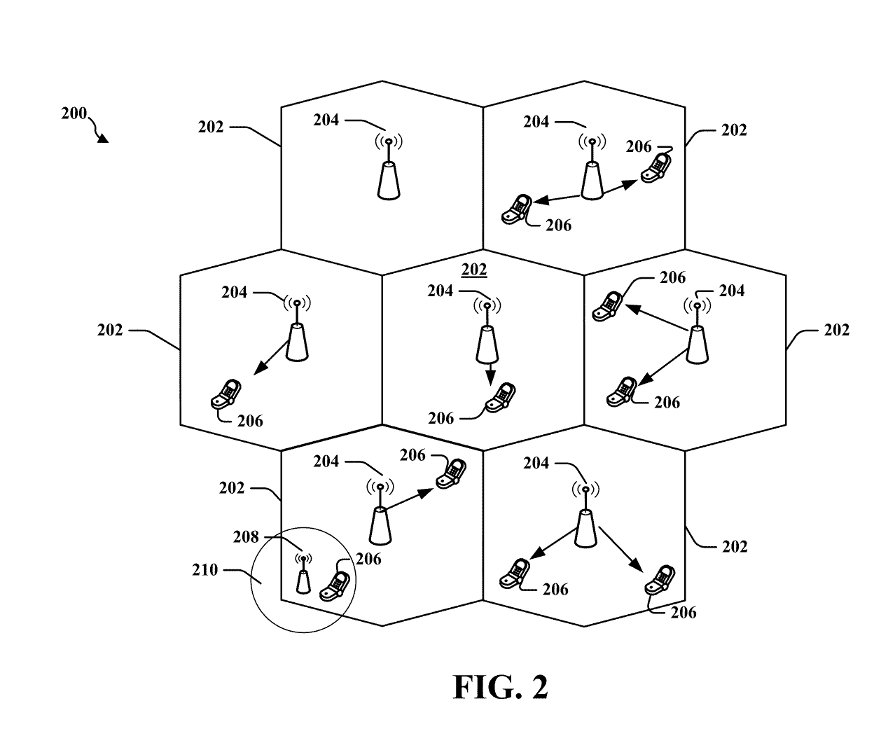

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

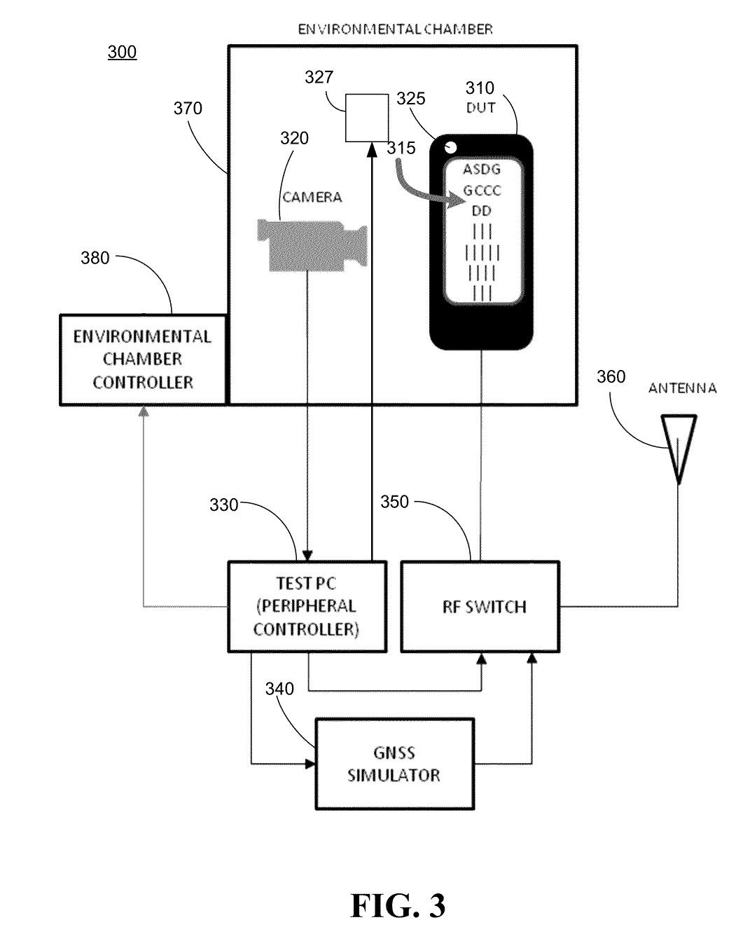

An apparatus and method is disclosed for mobile device testing. Referring to FIG. 3, a testing apparatus 300 consists of an optical control interface, where a device under test (DUT 310) displays control and test result codes on the DUT 310 screen. A camera 320 and peripheral test equipment controller 330 regularly scans the display 315 of the DUT 310 for control codes (e.g. Quick Response (QR) codes, barcodes, alphanumeric characters), interprets them, and relays the control to the appropriate peripheral device.

In one embodiment of testing, the testing apparatus may test GPS re-connection after a disconnect by running GPS start mode testing with “garage delay”: this is the case where the GPS signal (from a GNSS simulator 340) is cut off at the beginning of each start, and is reconnected after a given delay. The DUT 310 initially displays a code that indicates a start mode test will commence after a delay, e.g., in five seconds. The camera 320 receives an image of the code, and the test PC/peripheral controller 330 decodes image of the code, and may interpret it to cut the signal using an RF switch 350. The camera 320 preferably has sufficient resolution to accurately detect the image of the code. After some specified time interval, e.g., 30 seconds, the DUT 310 display 315 presents a code that can mean, for example, “reconnect signal,” and again the camera 320 scans the display 315, and the peripheral controller 330 decodes the code and controls the RF switch 350 to reconnect the GPS signal. The GPS signal may be detected with an antenna 360. After a number of seconds, the DUT 310 obtains a position fix, and reports this position fix with yet another displayed code (possibly also containing data about the fix, e.g. how many seconds it took). The test PC/controller 330 may then log this data for later review, for example, if a testing error occurs, or further debugging is required. Then the cycle repeats. If the GPS is unable to get a fix, even with the signal enabled, then, after a timeout period the DUT 310 displays a code indicating lack of position fix, and the test PC/controller 330 may generate an alert (e.g., to a test engineer) that there is a problem with the test run. Multiple codes, or animated codes may also be used to also transmit actual test logs (for example, transmission of large data quantities may use matrix bar codes, color codes, QR codes, alphanumerics). A significant subset of the logs, or in some cases all debug logs, could be transmitted to the test PC/controller 330 for immediate analysis during the test run. As one example, the entire test may be conducted with the DUT 310 contained in an environmental chamber 370 that may be controlled by an environmental chamber controller 380 to control, for example, temperature, pressure, electromagnetic interference, vibration, and other effects that may affect the test results. The environmental chamber controller 380 may also be controlled by the PC/controller to produce a specified environmental condition for the test.

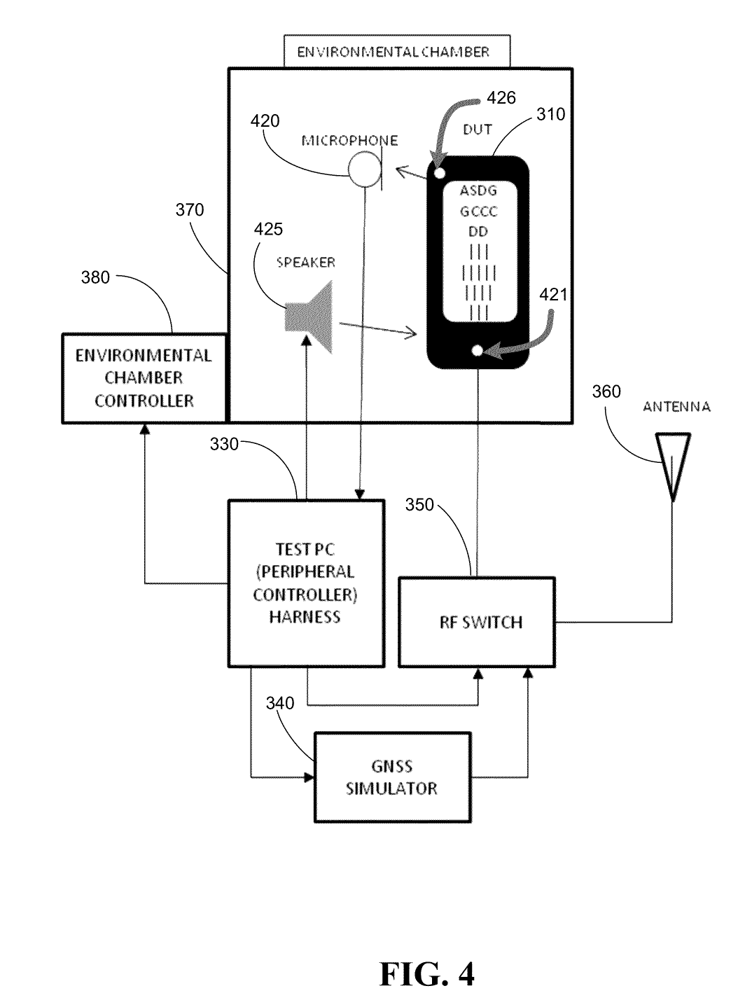

In FIG. 4, in a testing apparatus 400, the communication between the DUT 310 (e.g., a mobile phone) and the test PC/controller 330 has been replaced. Instead of using visual codes and a camera, a microphone 420 and speaker 425 may be used. The microphone 420 and speaker 425 may communicate with the DUT 310 via the built-in DUT microphone 421 and DUT speaker 426. The microphone 420 can listen for coded sounds from the DUT speaker 426 that indicate when to start or stop a test, and similarly the microphone 420 can report back to the PC/controller 330 via the microphone when a significant event has occurred. Self-test functions running on the DUT 310 can be initiated by control commands transmitted as coded sounds from the PC/controller 330 via the speaker 425 and detected by the DUT microphone 421. The microphone 420 may thus act with the PC/controller 330 to function much like an acoustic coupler modem. Sequences of beeps (analogous to Morse code or facsimile code) and pitch changes of the sounds may be used for different message codes.

In a still further embodiment, a combination of optical, audio and wired control (e.g., via the RF switch) may be used to perform tests and facilitate data logging.

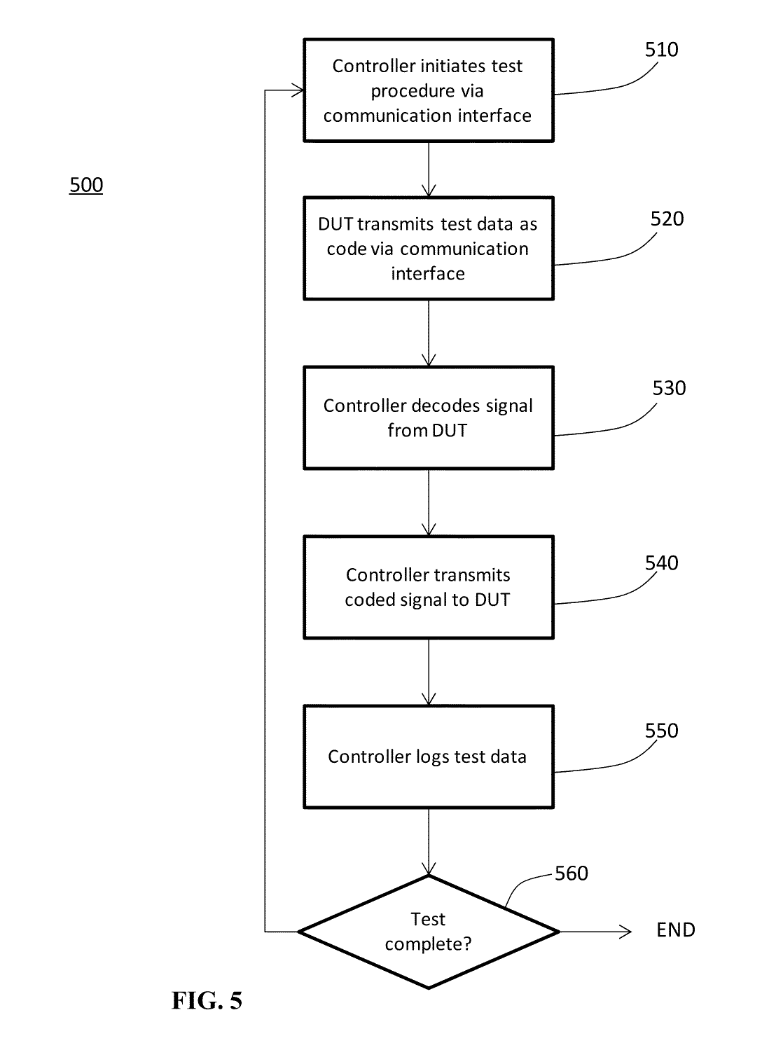

FIG. 5 is a block diagram illustrating a method 500 of testing a DUT. The method 500 may apply whether the communication interface is video, audio, simulated wireless communication via the RF switch 350, or a combination, and may simply be referred to as the communication interface to the DUT. In block 510 the controller 330 may initiate a test procedure via the communication interface. This may be accomplished in any of several ways. For example, the controller may send a simulated wireless command message to the DUT 310 by way of the RF switch 350 instructing the DUT 310 to begin self-diagnostic tests embedded in the DUT 310.

In block 520 code generated by the DUT 310 is transmitted over the communications interface to the controller 330. The transmission may include detection of code displayed on a screen of the DUT 310 by a camera 320 or by a microphone 420. In block 530 the code signal is decoded by the controller 330 to determine results of self-diagnostic tests.

In block 540 the controller may respond by transmitting a coded signal to the DUT 310 via the communication interface. For example, communication may be from a speaker 425 in the testing apparatus environmental chamber 370 to a microphone 421 in the DUT 310, or via a screen 327 in the testing apparatus environmental chamber 370 displaying coded images transmitted from the controller 330 and viewed by a DUT camera 325. Alternatively, communication may be from the controller 330 via the RF switch 350.

In block 550, the controller 330 may generate a log of test data and results, which may be reviewed during or after the tests. If testing is complete, in decision block 560 the completion of the test is indicated and the test ends. Otherwise, if additional testing or retesting is desired or required, decision block 560 continues the test procedure by returning to block 510.

In certain embodiments, the order of steps in the method 500 may be varied.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An apparatus for testing a device under test (DUT) comprising:
a peripheral controller configured to communicate with an application embedded in the DUT, wherein the application is configured to run self diagnostic tests; and
an audio interface arranged to transmit to and receive audio codes between the apparatus and the DUT on the basis of the tests, wherein the peripheral controller is coupled to the audio interface, being configured to encode and decode the audio codes.

2. The apparatus of claim 1, further comprising an environmental chamber, the environmental chamber coupled to the peripheral controller.

3. The apparatus of claim 2, wherein the environmental chamber comprises an environmental chamber controller coupled to the peripheral controller.

4. The apparatus of claim 1, wherein the DUT is coupled to the peripheral controller via a radio frequency (RF) switch.

5. The apparatus of claim 1, wherein the audio codes include at least one of a digital sound impulse, frequency variation, amplitude variation and any combination of digital sound impulse, frequency variation, and amplitude variation.

6. The apparatus of claim 1, wherein the audio interface comprises at least one of a microphone and a speaker.

7. The apparatus of claim 4, further comprising a Global navigation Satellite System Navigation (GNSS) simulator coupled to the peripheral controller and the RF switch.

8. The apparatus of claim 4, further comprising an antenna coupled to the RF switch.

9. An apparatus for testing a mobile device under test (DUT) comprising:
an application embedded in the DUT configured to run self-diagnostic tests;
an audio interface arranged to transmit and detect audio codes between the apparatus and the DUT on the basis of the tests; and
a peripheral controller, coupled to the audio input interface, configured to decode and encode the audio codes.

10. The apparatus of claim 9, further comprising an environmental chamber to contain the DUT, the chamber being coupled to the peripheral controller.

11. The apparatus of claim 10, wherein the environmental chamber comprises an environmental chamber controller coupled to the peripheral controller.

12. The apparatus of claim 9, wherein the DUT is coupled to the peripheral controller via a radio frequency (RF) switch.

13. The apparatus of claim 9, wherein the audio codes comprise at least one of a digital and an analog signals.

14. The apparatus of claim 9, wherein the audio interface comprises at least one or more of a microphone and a speaker.

15. The apparatus of claim 12, further comprising a Global navigation Satellite System Navigation (GNSS) simulator coupled to the peripheral controller and the RF switch.

16. The apparatus of claim 12, further comprising an antenna coupled to the RF switch.

17. A method of testing a mobile device under test (DUT) using a testing apparatus, the method comprising:
running an application embedded in the DUT configured to run self-diagnostic tests;
wherein running the application comprises:
transmitting encoded audio command signals via an audio interface from the testing apparatus to a microphone configured with the DUT to initiate the self diagnostic tests;
receiving audio response signals from the DUT generated on the basis of the tests via an audio interface configured with the testing apparatus; and
decoding the received audio response signals by a peripheral controller.

18. The method of claim 17 further comprising logging test results on the basis of the decoded audio response signals.

19. The method of claim 17, further comprising controlling by the peripheral controller an environmental chamber containing the DUT.

20. The method of claim 19, wherein controlling the environmental chamber comprises controlling an environmental chamber controller coupled to the peripheral controller.

21. The method of claim 17, wherein the DUT is coupled to the peripheral controller via a radio frequency (RF) switch.

22. The method of claim 17, wherein the encoded audio command signals and the received audio response signals include at least one or more of digital sound impulse, frequency variation, amplitude variation and any combination of digital sound impulse, frequency variation, and amplitude variation.

23. The method of claim 17, wherein the audio interface is at least one or more of a microphone and a speaker.

24. The method of claim 21, further comprising testing location determination using a Global navigation Satellite System Navigation (GNSS) simulator coupled to the peripheral controller and the RF switch.

25. The method of claim 21, wherein an antenna is coupled to the RF switch.

26. A method of testing a mobile device under test (DUT) comprising:
running an application configured to run self-diagnostic tests embedded in the DUT;
transmitting an audio code by the DUT on the basis of the self diagnostic test to a peripheral controller;
decoding the audio code by the peripheral controller; and
receiving by the DUT an audio coded signal from the peripheral controller on the basis of the decoded audio code emitted by the DUT.

27. The method of claim 26, further comprising controlling an environmental chamber containing the DUT by the peripheral controller.

28. The method of claim 27, wherein the controlling the environmental chamber comprises controlling an environmental chamber controller coupled to the peripheral controller.

29. The method of claim 26, wherein the DUT is coupled to the peripheral controller via a radio frequency (RF) switch.

30. The method of claim 26, wherein the audio code and the audio output signal comprise at least one of a digital and an analog signal.

31. The method of claim 26, wherein detecting the audio code comprises using a microphone.

32. The method of claim 26, wherein transmitting the audio code comprises using a speaker.

33. The method of claim 29, further comprising coupling a Global navigation Satellite System Navigation (GNSS) simulator to the peripheral controller and the RF switch.

34. The method of claim 29, further comprising coupling an antenna to the RF switch.

35. An apparatus for testing a device under test (DUT) comprising:
means for communicating with an application embedded in the DUT, wherein the application is configured to run self diagnostic tests; and
means for transmitting and receiving audio codes between the apparatus and the DUT on the basis of the tests; wherein
the means for communicating is coupled to the means for transmitting and receiving audio codes, the communicating means being configured to encode and decode the audio codes.

36. The apparatus of claim 35, further comprising a means for environmental control, the means for environmental control coupled to the communicating means.

37. The apparatus of claim 36, wherein the means for environmental control comprises a controller coupled to the means for communicating.

38. The apparatus of claim 35, wherein the DUT is coupled to the means for communicating via a radio frequency (RF) switch.

39. The apparatus of claim 35, wherein the audio codes include at least one of a digital sound impulse, frequency variation, amplitude variation and any combination of digital sound impulse, frequency variation, and amplitude variation.

40. The apparatus of claim 35, wherein the audio interface comprises at least one of a microphone and a speaker.

41. The apparatus of claim 38, further comprising a Global navigation Satellite System Navigation (GNSS) simulator coupled to the means for communication and the RF switch.

42. The apparatus of claim 38, further comprising an antenna coupled to the RF switch.

43. A non-transitory computer readable media including program instructions which when executed by a processor cause the processor to perform the method of off-line testing of a device under test (DUT), the instructions comprising:
code for running an application embedded in the DUT configured to run self-diagnostic tests;
wherein the application comprises:
code for transmitting encoded audio command signals via an audio interface from the testing apparatus to a microphone configured with the DUT to initiate the self diagnostic tests;
code for receiving audio response signals from the DUT generated on the basis of the tests via an audio interface configured with the testing apparatus; and
code for decoding the received audio response signals by a peripheral controller.

44. The non-transitory computer readable media of claim 43, further comprising code for controlling an environmental chamber containing the DUT by the peripheral controller.

45. The non-transitory computer readable media of claim 44, further comprising code for controlling the environmental chamber via an environmental chamber controller coupled to the peripheral controller.

46. The non-transitory computer readable media of claim 43, further comprising code for instructing the peripheral controller to control a radio frequency (RF) switch coupled to the DUT and the peripheral controller.

47. The non-transitory computer readable media of claim 46, further comprising code for controlling coupling a Global navigation Satellite System Navigation (GNSS) simulator coupled to the peripheral controller and the RF switch.
